(19) United States
(12) Patent Application Publication
(10) Pub. No.: US 2024/0288878 A1
(43) Pub. Date: Aug. 29, 2024

(54) MOBILE ROBOT AND CONTROL METHOD THEREFOR

(71) Applicant: Samsung Electronics Co., Ltd., Suwon-si (KR)

(72) Inventors: Minwoo RYU, Suwon-si (KR); Seokhyun KANG, Suwon-si (KR); Jinhee KIM, Suwon-si (KR); Sangsik YOON, Suwon-si (KR); Donghun LEE, Suwon-si (KR)

(21) Appl. No.: 18/649,866

(22) Filed: Apr. 29, 2024

Related U.S. Application Data
(63) Continuation of application No. PCT/KR2022/017869, filed on Nov. 14, 2022.

(30) Foreign Application Priority Data
Jan. 11, 2022 (KR) 10-2022-0004118

(51) Int. Cl. G05D 1/622; B25J 5/00; B25J 11/00; G05D 1/243

(52) U.S. Cl. CPC G05D 1/622; B25J 5/007; B25J 11/0085; G05D 1/243

(57) ABSTRACT

A robot includes: a main body, one or more optical sensors provided at a lower portion of the main body, memory storing at least one program, and at least one processor, comprising processing circuitry, electrically connected with the optical sensors and the memory and configured to execute at least one instruction of the program. Each optical sensor includes: one or more light emitting elements for emitting light of a first wavelength band, one or more light receiving elements for receiving light of a second wavelength band induced by the light of the first wavelength band, and one or more optical filter layers arranged on the one or more light receiving elements to pass the light of the second wavelength band. The at least on processor is configured to obtain first detection information based on two or more sensing values obtained through the one or more light receiving elements, and, control to avoid a position associated with the first detection information when the first detection information is obtained.

### CROSS-REFERENCE TO RELATED APPLICATIONS

This application is a Bypass Continuation of International Application No. PCT/KR2022/017869, filed Nov. 14, 2022, which claims priority to Korean Patent Application No. 10-2022-0004118, filed Jan. 11, 2022, the disclosures of which are herein incorporated by reference in their entirety.

### BACKGROUND

### 1. Field

The disclosure relates to a moving robot and a method for controlling the same.

### 2. Description of Related Art

In general, robots have been developed for industrial use and have played a part in factory automation. In recent years, broadened applications of robots are leading to development of medical and aerospace robots, and even robots for home use. A moving robot is a representative home robot. Moving robots may move on their own to perform a purported operation. Moving robots include, e.g., cleaning robots or assistant robots. Moving robots travel on a floor or a road on their own without a user's manual control. Thus, the traveling algorithm take in critical consideration a condition of the floor or road or presence of various obstacles.

### SUMMARY

The disclosure proposes a moving robot that identifies a type of liquid or solid contaminants on a floor and drives in an appropriate manner based on the type and a method for controlling the same.

A robot according to an embodiment of the disclosure may comprise a main body, one or more optical sensors provided at a lower portion of the main body, memory storing at least one program, and at least one processor, comprising processing circuitry, electrically connected with the one or more optical sensors and the memory and configured to execute at least one instruction of the program. The optical sensor may include one or more light emitting elements configured to emit light of a first wavelength band, one or more light receiving elements configured to receive light of a second wavelength band induced by the light of the first wavelength band, and one or more optical filter layers arranged on the one or more light receiving elements to pass the light of the second wavelength band. Further, the at least one processor, individually and/or collectively, may be configured to obtain first detection information based on two or more sensing values obtained through the one or more light receiving elements, and control to avoid a position associated with the first detection information if the first detection information is obtained.

According to an embodiment of the disclosure, the light receiving elements may include first and second light receiving elements. The first light receiving element may be disposed adjacent to the one or more light emitting elements. The second light receiving element may be disposed farther from the one or more light emitting elements than the first light receiving element is. The at least one processor, individually and/or collectively, may be configured to obtain the first detection information based on a first sensing value obtained through the first light receiving element and a second sensing value obtained through the second light receiving element.

According to an embodiment of the disclosure, the first and second light receiving elements may be arranged on a single substrate.

According to an embodiment of the disclosure, the first and second light receiving elements may be arranged on different substrates, respectively. The different substrates may be disposed to be spaced apart from each other by a predetermined distance.

According to an embodiment of the disclosure, the first and second light receiving elements may be spatially separated by a barrier.

According to an embodiment of the disclosure, the one or more light emitting elements may be disposed more adjacent to the barrier than the first light receiving element is.

According to an embodiment of the disclosure, the at least processor, individually and/or collectively, may be configured to obtain the first detection information when the first sensing value exceeds a preset first threshold, and the second sensing value is less than a preset second threshold.

According to an embodiment of the disclosure, the robot may further comprise one or more moisture sensors. The one or more moisture sensors may be electrically connected with the at least one processor. The at least one processor, individually and/or collectively, may be configured to obtain second detection information when a sensing value obtained through the one or more moisture sensors exceeds a threshold and avoid a position associated with the second detection information when the second detection information is obtained, and disregard the first detection information when the second detection information is not obtained. As the first detection information (or first detection information field) is disregarded, the robot may pass through the position associated with the first detection information without avoiding the position.

According to an embodiment of the disclosure, the robot may further comprise one or more moisture sensors. The one or more moisture sensors may be electrically connected with the at least one processor. The at least one processor, individually and/or collectively, may be configured to obtain second detection information when a sensing value obtained through the one or more moisture sensors exceeds a threshold and avoid a position associated with the first and second detection information when both the first detection information and the second detection information are obtained, and disregard the obtained first detection information or second detection information when at least a portion of the first and second detection information is not obtained. Accordingly, the robot drives while avoiding the position associated with the detection information if both the first and second detection information are obtained but, in the other cases, passes through the position.

According to an embodiment of the disclosure, the robot may further comprise one or more moisture sensors. The one or more moisture sensors may be electrically connected with the at least one processor. The at least one processor, individually and/or collectively, may be configured to obtain second detection information when a sensing value obtained through the one or more moisture sensors exceeds a threshold and, when at least one of the first or second detection information is obtained, control to avoid the position associated with the obtained detection information.

According to an embodiment of the disclosure, the at least one processor, individually and/or collectively, may be configured to periodically control the one or more light emitting elements in a turn-on mode or a turn-off mode, and may configured to obtain the first detection information based on a first sensing value obtained through the one or more light receiving elements in the turn-on mode and a second sensing value obtained through the one or more light receiving elements in the turn-off mode.

According to an embodiment of the disclosure, the one or more light receiving elements may include a first area receiving light of a second wavelength band induced by the light of the first wavelength band and disposed adjacent to the one or more light emitting elements and a second area receiving the light of the first wavelength band and disposed farther from the one or more light emitting elements than the first area is. Further, the at least one processor may be configured to obtain first detection information based on a first sensing value obtained through the first area and a second sensing value obtained through the second area and control to avoid a position associated with the first detection information if the first detection information is obtained.

According to an embodiment of the disclosure, the first and second areas may be separated by a barrier.

According to an embodiment of the disclosure, the first wavelength band may be a near-ultraviolet wavelength band, and the second wavelength band may be a near-infrared wavelength band.

A robot according to another embodiment of the disclosure may comprise a main body, one or more optical sensors provided at a lower portion of the main body, memory storing at least one program, and at least one processor, comprising processing circuitry, electrically connected with the one or more optical sensors and the memory and configured to execute at least one instruction of the program. The optical sensor may include one or more light emitting elements emitting light of a first wavelength band, one or more first light receiving elements for receiving light of a second wavelength band induced by the light of the first wavelength band, a second light receiving element for receiving the light of the first wavelength band, a first optical filter layer arranged on the first light receiving element to pass the light of the second wavelength band, and a second optical filter layer arranged on the second light receiving element to pass the light of the first wavelength band. Further, the processor may obtain first detection information based on first and second sensing values obtained through the first and second light receiving elements and control to avoid a position associated with the first detection information when the first detection information is obtained, and obtain second detection information based on the second sensing value obtained through the second light receiving element and control to move a predetermined distance or time in a direction opposite to a position associated with the second detection information when the second detection information is obtained.

A method for controlling a robot including an optical sensor including one or more light emitting elements emitting light of a first wavelength band, one or more light receiving elements for receiving light of a second wavelength band induced by the light of the first wavelength band, and one or more optical filter layers arranged on the light receiving element to transmit the light of the second wavelength band, according to another embodiment of the disclosure, may comprise emitting the light of the first wavelength band toward a floor using the light emitting element, receiving the light of the second wavelength band induced by the light of the first wavelength band through the first and second light receiving elements, obtaining first detection information based on first and second sensing values obtained by the first and second light receiving elements, respectively, and controlling to avoid a position associated with the first detection information when the first detection information is obtained.

According to another embodiment of the disclosure, the one or more light receiving elements may include a first light receiving element provided to receive the light of the second wavelength band induced by the light emitting element and a second light receiving element provided to receive the light of the second wavelength band included in an external light source. Obtaining the first detection information may include comparing a second sensing value obtained by the second light receiving element with a second threshold when a first sensing value obtained by the first light receiving element exceeds a first threshold and obtaining the first detection information when the second sensing value is less than the second threshold.

According to another embodiment of the disclosure, the robot may further include one or more moisture sensors. The method may comprise obtaining second detection information when a sensing value obtained through the moisture sensor exceeds a threshold and, when the second detection information is not obtained, disregarding the first detection information and, when the second detection information is obtained, controlling to avoid a position associated with the second detection information.

The moving robot and method for controlling the same according to various embodiments of the disclosure may identify the type of liquid and solid contaminants on the floor through sensors and drive in an appropriate manner based on the type.

Effects of the present disclosure are not limited to the foregoing, and other unmentioned effects would be apparent to one of ordinary skill in the art from the following description. In other words, unintended effects in practicing embodiments of the disclosure may also be derived by one of ordinary skill in the art from the embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates a perspective view of a robot according to various embodiments of the disclosure;

FIG. 1B illustrates a bottom view the robot of FIG. 1A;

FIG. 2A illustrates a perspective view of a robot according to another embodiment of the disclosure;

FIG. 2B illustrates a bottom view of the robot of FIG. 2A;

FIG. 2C illustrates a reference view of the robot of FIG. 2B;

FIG. 3 illustrates a block diagram of a robot according to various embodiments of the disclosure;

FIGS. 4 to 7 illustrate a structure of an optical sensor according to various embodiments of the disclosure; and

FIGS. 8 to 12 illustrate examples of a control method according to various embodiments of the disclosure.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

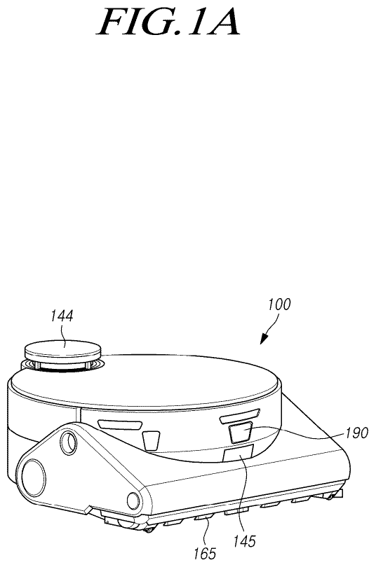

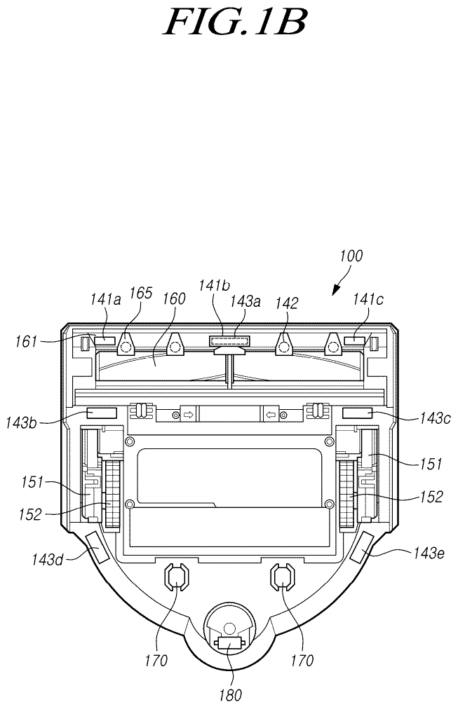

FIGS. 1A through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure are now described with reference to the accompanying drawings in such a detailed manner as to be easily practiced by one of ordinary skill in the art. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

FIG. 1A illustrates a perspective view of a robot according to various embodiments of the disclosure, and FIG. 1B illustrates a bottom view of the robot of FIG. 1A.

FIGS. 1A and 1B illustrate a robot 100, e.g., a dry cleaning robot. Referring to FIGS. 1A and 1B, the robot 100 includes one or more sensors. One or more sensors are provided in a main body of the robot 100. Depending on the type and/or function, the sensor may be disposed at a front, rear, side, or lower portion of the main body. Position of the sensor is closely related to a driving direction and a driving pattern of the robot 100.

According to various embodiments of the disclosure, the sensor may include one or more of contaminant sensors 141a, 141b, and 141c, a moisture sensor 142, anti-fall sensors 143a, 143b, 143c, 143d, and 143e, a LiDAR sensor 144, and a 3D sensor 145.

According to various embodiments of the disclosure, the contaminant sensors 141a, 141b, and 141c may detect a presence or absence of contaminants (e.g., urine) on a floor. The robot 100 may detect contaminants in advance through the contaminant sensors 141a, 141b, and 141c, thereby preventing contamination of the cleaning tool 160 (e.g., a brush, a cleaning cloth, etc.) or contamination of the wheel 151 from contaminants present on the floor. In this disclosure, the cleaning tool 160 is can be simply referred to as brush 160. The contaminant sensors 141a, 141b, and 141c may be configured as optical sensors. The contaminant sensors 141a, 141b, and 141c may include one or more light emitting elements for emitting UV light, and one or more light receiving elements for receiving a predetermined wavelength band (e.g., a near-infrared wavelength band or 550 nm to 650 nm) of fluorescence or phosphorescence induced by UV light. The light receiving element may include one or more light receiving electrodes and one or more light receiving semiconductor layers.

According to various embodiments of the disclosure, the light receiving elements may include a main light receiving element and one or more sub light receiving elements distinguished from the main light receiving element. The sub light receiving element may also be configured to receive the same wavelength band (e.g., near-infrared wavelength band, or 550 nm to 650 nm) as the main light receiving element. The light receiving electrodes constituting the main light receiving element and the sub light receiving element may be formed of the same material, but are not limited thereto. Meanwhile, an optical filter layer (e.g., an optical bandpass filter) for passing light (for example, only light) of a predetermined wavelength band (e.g., a near-infrared wavelength band or 550 nm to 650 nm) may be arranged on the main light receiving element and the sub light receiving element.

According to various embodiments of the disclosure, the moisture sensor 142 may detect a presence or absence of a liquid positioned on a driving path of the robot 100. The moisture sensor 142 may identify the presence or absence of a liquid based on a change in permittivity or resistance. The moisture sensor 142 may be disposed on a front or a lower portion of the main body to identify a change in permittivity or resistance.

According to various embodiments of the disclosure, the moisture sensor 142 may be disposed ahead of the brush 160 and/or the contaminant sensors 141a, 141b, and 141c provided in the robot 100. When a plurality of moisture sensors 142 are disposed, the moisture sensors 142 may be arranged to be spaced apart from each other at predetermined intervals. In this case, the moisture sensors 142 may be arranged in a row. The moisture sensors 142 may be arranged along a reference line orthogonal to the driving direction of the robot 100. In the case of a dry cleaning robot 100 including a brush 160, the brush 160 is generally disposed to be orthogonal to the driving direction. In this case, the moisture sensor 142 may be disposed along a direction in which the brush 160 extends. Meanwhile, various embodiments of the disclosure are not limited to arranging the moisture sensors 142 in a row.

According to various embodiments of the disclosure, when the plurality of moisture sensors 142 are provided, a controller may estimate a range of the liquid based on at least one of a number or positions of the sensors detecting moisture among the plurality of moisture sensors 142.

According to various embodiments of the disclosure, the moisture sensor 142 may be formed in at least a partial area of a brush cover 161. According to various embodiments of the disclosure, the brush cover 161 has, on its front, one or more protrusions 165 having a predetermined inclination angle toward the floor. The protrusion 165 may be formed to extend from a lower side of the brush cover 161 to the rear of the main body. One end of the protrusion 165 may be formed to be spaced apart from the floor by a predetermined distance. In various embodiments of the disclosure, a space for mounting a sensor electrode of the moisture sensor 142 may be formed behind the protrusion 165, and an opening for bringing the liquid on the floor in contact with the sensor electrode may be formed in front of the protrusion 165. Assuming that there is a liquid on the floor while driving along the driving path, the moisture sensor 142 may identify the liquid on the floor before the optical sensor does, and prevent a problematic situation in which the robot 100 passes over the liquid.

Alternatively, according to various embodiments of the disclosure, the moisture sensor 142 may be formed in at least a portion of the main body. According to various embodiments of the disclosure, one or more protrusions 165 having a predetermined inclination angle toward the floor may be formed at the front of the main body. The protrusion 165 may be formed to extend from a lower side of the main body to the rear of the main body. One end of the protrusion 165 may be formed to be spaced apart from the floor by a predetermined distance. In various embodiments of the disclosure, a space for mounting the sensor electrode of the moisture sensor 142 may be formed behind the protrusion 165, and an opening for bringing the liquid on the floor in contact with the sensor electrode may be formed in front of the protrusion 165.

According to various embodiments of the disclosure, one or more openings may be provided in front of the protrusion 165, and the sensor electrode of the moisture sensor 142 may be positioned in the rear. The liquid on the floor may pass through an outer opening and contact the sensor electrode. The moisture sensor 142 may generate a detection signal based on the resistance or permittivity changed in response to the contact of the liquid. The sensor electrode of the moisture sensor 142 may be disposed behind at least some of the two or more protrusions 165 of the brush cover 161. In an embodiment, the sensor electrodes of the moisture sensor 142 may be disposed behind all the protrusions 165. A predetermined space formed on the brush cover 161 may be provided between the plurality of protrusions 165.

According to various embodiments of the disclosure, the anti-fall sensors 143a, 143b, 143c, 143d, and 143e may be formed on the lower side of the robot 100 to detect a step. The anti-fall sensors 143a, 143b, 143c, 143d, and 143e are configured to measure a relative distance to the floor. The anti-fall sensors 143a, 143b, 143c, 143d, and 143e may be variously configured within a range capable of detecting the positions where the anti-fall sensors 143a, 143b, 143c, 143d, and 143e are formed and the relative distance to the floor (a distance in a vertical direction from the floor or a distance in an inclined direction from the floor). The anti-fall sensors 143a, 143b, 143c, 143d, and 143e may be formed of an optical sensor including a light emitting element and a light receiving element, and in particular, the anti-fall sensors 143a, 143b, 143c, 143d, and 143e may be formed of an infrared sensor using light of an infrared wavelength band. In the disclosure, the anti-fall sensors 143a, 143b, 143c, 143d, and 143e may be referred to as cliff sensors.

According to various embodiments of the disclosure, the light detection and ranging (LiDAR) sensor 144 may be provided at the rear of the robot 100 to generate a map including obstacles, etc. The LiDAR sensor 144 may detect an obstacle, a wall surface, or the like based on a time of flight (ToF) or phase difference of transmission/reception signals using laser light. The map generation by the LiDAR sensor 144 may be omitted in some cases. For example, when the map is stored in the memory, the map generation by the LiDAR sensor 144 may be omitted. However, when the map is not stored in the memory, the robot 100 may generate an initial map using the LiDAR sensor 144.

According to various embodiments of the disclosure, the 3D sensor 145 may be disposed at the front of the robot 100 to identify a shape of the object positioned on the driving path of the robot 100. The 3D sensor 145 may be implemented as, e.g., a depth camera, a ToF sensor, and a ToF camera, but is not limited thereto. According to various embodiments of the disclosure, the robot 100 may identify the shape of the object positioned on the driving path through the 3D sensor 145, and identify a type of the object based on the shape. In this case, the robot 100 may identify the type of the object using a classifier pre-stored in the memory. Here, the classifier may include an artificial neural network model (ANN model), and such the artificial neural network model may be pre-trained and provided using learning data in which the type of the object is labeled to the data to be applied to an input layer, but is not limited thereto.

The robot 100 according to various embodiments of the disclosure includes the brush 160 and the brush cover 161. The brush 160 may be provided in a space formed in a lower side of the robot 100. The brush 160 is provided in a cylindrical shape, but is not limited thereto. The brush 160 receives power from a motor through a connecting member at two opposite ends thereof to rotate, and supports collection of contaminants into an inside by brushing on the floor.

According to various embodiments of the disclosure, the brush cover 161 is provided to surround an outer surface of at least a portion of the brush 160. The brush cover 161 has an opening on a lower side for exposing the brush 160 to the outside and contacting the floor. In the brush cover 161, an inner circumferential surface of the brush 160 may be formed to face an outer circumferential surface of the brush 160, but is not limited thereto. Two or more protrusions 165 may be formed at the front of the brush cover 161. FIGS. 1A and 1B illustrate an example in which the number of protrusions 165 is five, but are not limited thereto. The protrusions 165 are configured so that left and right sides of the robot 100 are symmetrical.

According to various embodiments of the disclosure, the robot 100 includes the wheel 151 and a wheel motor 152 for rotating the wheel 151. The robot 100 may move using the wheel 151. The plurality of wheels 151 may be independently rotated by each wheel motor 152.

According to various embodiments of the disclosure, the robot 100 may include a charging terminal 170. The robot 100 may be in electrical contact with a charging station through the charging terminal 170. The charging station may charge a battery of the robot 100 through the charging terminal 170. The charging terminal 170 may be disposed on a lower portion or the rear side of the main body, but is not limited thereto.

According to various embodiments of the disclosure, the robot 100 may further include a sub wheel 180. The sub wheel 180 is used to stabilize the posture of the robot 100 and prevent the robot 100 from falling. The sub wheel 180 supports the robot 100 and is formed in a roller or caster shape.

According to various embodiments of the disclosure, the robot 100 may include a camera 190. The camera 190 may be provided on the front side of the main body. The camera 190 captures a front of the driving direction of the robot 100, and stores the captured image data or video data in the memory. Then, the robot 100 may transmit the captured image data or video data to another external device in response to a request.

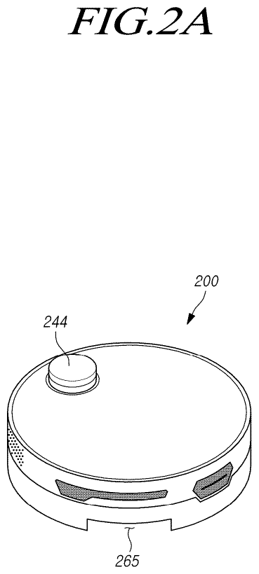

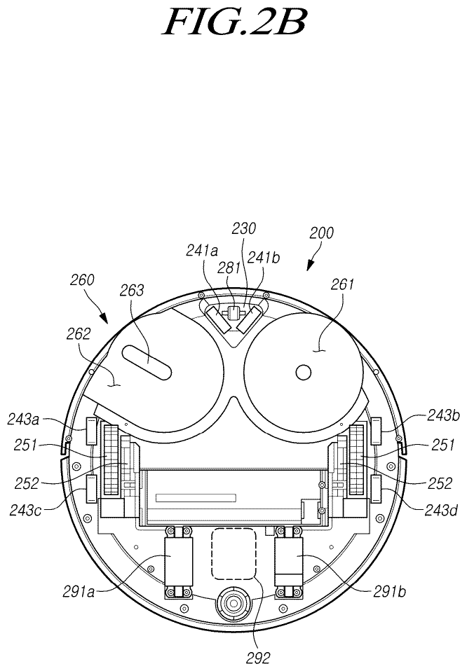

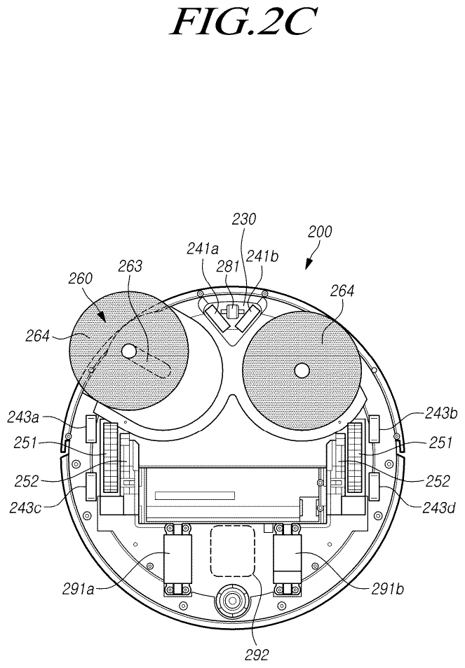

FIG. 2A illustrates a perspective view of a robot according to another embodiment of the disclosure, and FIG. 2B illustrates a bottom view of the robot of FIG. 2A.

FIGS. 2A and 2B illustrate a robot 200, more specifically, a wet cleaning robot 200. Referring to FIGS. 2A and 2B, the robot 200 includes one or more sensors. One or more sensors are configured in the body of the robot 200. The sensor may be disposed on a front side, lower side, or rear side of the main body depending on a type and/or function. Position of the sensor is closely related to a driving direction and a driving pattern of the robot 200.

According to the embodiment illustrated in FIGS. 2A and 2B, the sensor may include one or more of contaminant sensors 241a and 241b, a moisture sensor (not illustrated), anti-fall sensors 243a, 243b, 243c, and 243d, and a LiDAR sensor 244.

According to various embodiments of the disclosure, the robot 200 may include a cleaning tool 260 for performing wet cleaning using a cleaning cloth. The cleaning tool 260 is provided in front of the main body. The cleaning tool 260 includes a rotating plate 264 and a guide device 263 for moving the rotating plate 264. The rotating plate 264 includes rotating plate areas 261 and 262. The rotating plate area includes a first rotating plate area 261 and a second rotating plate area 262. The first rotating plate area 261 does not include an opening area 265 for the rotating plate 264 to move to an outside of the main body, and the second rotating plate area 262 includes an opening area 265 for the rotating plate 264 to move to the outside of the main body.

According to various embodiments of the disclosure, the guide device 263 includes a connecting member and a guide hole. The connecting member may move along the guide hole. The connecting member may be connected to the rotating plate 264. Accordingly, the rotating plate 264 may be moved inside or outside the main body corresponding to a movement of the connecting member. Meanwhile, FIGS. 2B and 2C illustrate an example in which the opening area 265 is formed in a right side of the main body, but the disclosure is not limited thereto, and the opening area 265 may be formed in a left side of the main body or the left and right sides of the main body.

According to various embodiments of the disclosure, one side of the rotating plate 264 is provided with an attachment surface for attaching the cleaning cloth, and the rotating plate 264 is connected to the connecting member through the other side. The connecting member may protrude toward the floor through the guide hole to be coupled to the rotating plate 264, and the connecting member may be moved along the guide hole. As the connecting member moves along the guide hole, the rotating plate 264 connected to the connecting member may also move. The guide hole may be formed to get away from a center of a lower side of the robot 200 to an outer periphery of the main body, and accordingly, the rotating plate 264 moving through the guide hole may move away from the center of the main body of the robot 200 to the outer periphery. As the rotating plate 264 moves along the guide hole, at least a portion of the rotating plate 264 may be exposed outside the main body. In the disclosure, an operation of the robot 200 in which at least a portion of the rotating plate 264 is exposed to the outside of the main body may be referred to as a pop-out operation.

Meanwhile, according to various embodiments of the disclosure, the rotating plate 264 is spaced apart from the floor by a predetermined interval. For example, the interval between the floor and the rotating plate 264 may be smaller than the thickness of the cleaning cloth. If the cleaning cloth is attached to the attachment surface of the rotating plate 264, the cleaning cloth is strongly in tight contact with the floor. As such, since the cleaning cloth is in tight contact with the floor, wet cleaning may be effectively performed.

According to various embodiments of the disclosure, the sensor may include one or more of contaminant sensors 241a and 241b, the moisture sensor (not shown), the anti-fall sensor, and the LiDAR sensor. The contaminant sensors 241a and 241b, the moisture sensor (not shown), the anti-fall sensor, and the LiDAR sensor illustrated in FIGS. 2A and 2B have the same functions as the contaminant sensors 141a, 141b and 141c, the moisture sensor 142, the anti-fall sensor 143a, 143b, 143c, 143d and 143e, and the LiDAR sensor 144 of the robot 100, respectively, illustrated in FIGS. 1A and 1B, and thus additional descriptions will be omitted, with the description focusing primarily on the positions of the sensors.

According to various embodiments of the disclosure, a protrusion 230 may be formed at a lower portion of the main body. The protrusion 230 is formed to protrude from the lower portion of the main body toward the floor by a predetermined width. The protrusion 230 is provided at the front of the main body. At least one of one or more sub wheels 281, one or more contaminant sensors 241a and 241b, and one or more moisture sensors (not shown) may be disposed on one or more surfaces of the protrusion 230. According to various embodiments of the disclosure, the protrusion 230 may have one lower side and three or more side surfaces. The protrusion 230 may be configured to have a smaller area toward the floor. Among the side surfaces of the protrusion 230, a surface positioned in front of the main body may have an inclined surface inclined toward the rear of the main body. Through this inclined surface, the robot 200 having the protrusion 230 may easily climb the obstacle in front.

According to various embodiments of the disclosure, a sub wheel 281 is provided to climb a threshold forward. Since the cleaning cloth forms a high frictional force with the floor, it is difficult for the wet cleaning robot 200 to climb the threshold forward. The sub wheel 281 formed on the protrusion 230 comes into contact with the threshold before the cleaning cloth does when climbing forward. As such, the robot 200 may easily climb the threshold using the sub wheel 281 provided on the protrusion 230.

According to various embodiments of the disclosure, the contaminant sensors 241a and 241b and/or the moisture sensor (not shown) may be disposed on the protrusion 230. The contaminant sensors 241a and 241b and/or the moisture sensor (not shown) may be disposed along an edge of the protrusion 230. FIG. 2B illustrates an example in which two contaminant sensors 241a and 241b are provided, but various embodiments of the disclosure are not limited thereto. In various embodiments of the disclosure, the moisture sensor (not illustrated) may be disposed at at least one of the positions where the contaminant sensors 241a and 241b are disposed, or may be disposed ahead of the contaminant sensors 241a and 241b. In various embodiments of the disclosure, the moisture sensor (not shown) and the contaminant sensors 241a and 241b may be selectively disposed on at least one of the front side and/or the lower side of the protrusion 230. In an embodiment, the moisture sensor (not shown) may be disposed on the front side of the protrusion 230, and the contaminant sensors 241a and 241b may be disposed on the lower side of the protrusion 230. In another embodiment, the moisture sensor (not shown) and the contaminant sensors 241a and 241b may be disposed on the front side of the protrusion 230. In another embodiment, the moisture sensor (not shown) and the contaminant sensors 241a and 241b may be disposed on the lower side of the protrusion 230.

According to various embodiments of the disclosure, the robot 200 includes a wheel 251 and a wheel motor 252 for rotating the wheel 251. The robot 200 may move or rotate by controlling the wheel motor 252. The wheels 251 may be disposed at two opposite ends of the lower side of the robot 200 and may be independently rotated by each wheel motor 252.

According to various embodiments of the disclosure, the anti-fall sensor may be disposed adjacent to the wheel 251. For example, the anti-fall sensor may be disposed adjacent to the wheel housing in which the wheel 251 is received. Further, the anti-fall sensor may be disposed between an edge of the main body and the wheel 251.

According to various embodiments of the disclosure, one or more vibration plates 291a and 291b may be provided on the rear lower side. An attachment surface is provided on one side of the vibration plate 291a and 291b. The cleaning cloth may be attached to the rear lower side of the robot 200 through the attachment surface of the vibration plate 291a and 291b. The vibration plate 291a and 291b may be connected to a vibration motor 292 to vibrate.

FIG. 2C illustrates a reference view of the robot of FIG. 2B.

Referring to FIG. 2C, it may be understood that the rotating plate 264 of the robot 200 is exposed to the outside of the main body through the connecting member. The robot 200 may move the connecting member along the guide groove based on a control command of the controller. When the connecting member moves outward from the center of the main body, the rotating plate 264 connected to the connecting member also moves outward from the main body. According to various embodiments of the disclosure, the connecting member and the guide hole for moving the rotating plate 264 may be provided only for one of the two rotating plates 264. The rotating plate 264 provided with the connecting member and the guide plate may be exposed to the outside of the main body as the connecting member moves, and the other rotating plate 264 may not be exposed to the outside of the main body because there is no connected connecting member. In a portion in which the connecting member and the guide groove are provided, an opening area 265 corresponding to the diameter of the rotating plate 264 may be provided so that the rotating plate 264 may be exported to the outside.

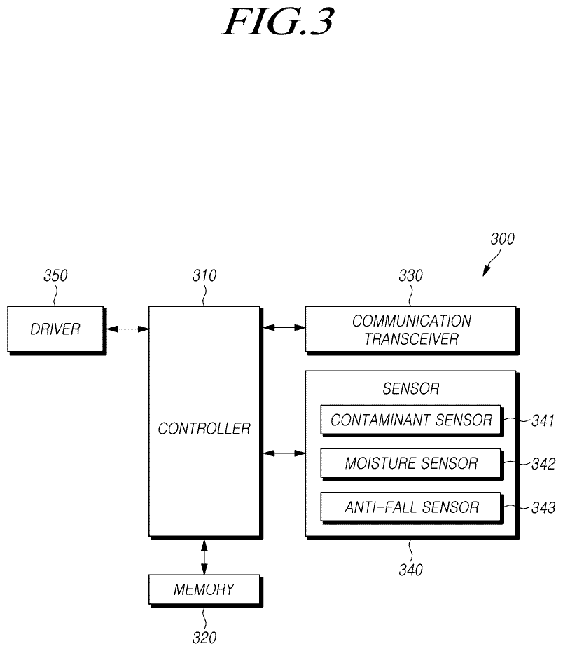

FIG. 3 illustrates a block diagram of a robot according to various embodiments of the disclosure.

Referring to FIG. 3, a robot 300 according to various embodiments of the disclosure may include, but is not limited to, a cleaning robot 300, a dry cleaning robot, and a wet cleaning robot. The robot 300 according to various embodiments of the disclosure is a robot device equipped with wheels for driving, and in some cases, is provided as a robot 300 that further includes a cleaning function.

According to various embodiments of the disclosure, the robot 300 may include a controller 310, memory 320, a communication transceiver 330, a sensor 340, and/or a driver 350. The memory 320, the communication transceiver 330, the sensor, and/or the driver 350 may be electrically or functionally connected with the controller 310. The controller 310 may control components constituting the robot 300 by generating and transmitting a control command

According to various embodiments of the disclosure, the controller 310 may include a storage and processing circuit part for supporting an operation of the robot 300. The storage and processing circuit part may include storage, such as non-volatile memory (e.g., flash memory, or other electrically programmable ROM configured to form a solid state drive (SSD)) or volatile memory (e.g., static or dynamic RAM). The processing circuit part in the controller 310 may be used to control the operation of the robot 300. The processing circuit part may be based on one or more microprocessor(s), microcontroller(s), digital signal processor(s), baseband processor(s), power management section(s), audio chip(s), or application specific integrated circuit(s).

According to various embodiments of the disclosure, the memory 320 may include a memory area for one or more controllers 310 for storing variables used in a protocol, configuration, control, and other functions of the robot 300, including operations corresponding to or including any one of methods and/or procedures described as an example in the disclosure. Further, the memory 320 may include non-volatile memory, volatile memory, or a combination thereof. Further, the memory 320 may interface with a memory slot that enables insertion and removal of removable memory cards in one or more formats (e.g., SD card, Memory stick, compact flash, etc.).

According to various embodiments of the disclosure, the communication transceiver 330 may include a wireless communication transceiver or an RF transceiver. The wireless communication transceiver may include, for example, Wi-Fi, BT, GPS or NFC. For example, the wireless communication transceiver may provide a wireless communication function using a radio frequency. Additionally or alternatively, the wireless communication transceiver may include a network interface or modem for connecting the robot 300 with a network (e.g., Internet, LAN, WAN, telecommunication network, cellular network, satellite network, POTS or 5G network). The RF transceiver may be responsible for data transmission/reception, e.g., transmitting and receiving data RF signals or invoked electronic signals. As an example, the RF transceiver may include, e.g., a power amp module (PAM), a frequency filter, or a low noise amplifier (LNA). The RF transceiver may further include components (e.g., conductors or wires) for communicating radio waves in a free space upon performing wireless communication.

According to various embodiments of the disclosure, the sensor 340 may include one or more of a contaminant sensor 341, a moisture sensor 342, and an anti-fall sensor 343.

According to various embodiments of the disclosure, the contaminant sensor 341 may emit UV light and may receive fluorescence or phosphorescence of a predetermined wavelength induced by the UV light. For example, when urine is irradiated with UV light, the urine may emit fluorescence or phosphorescence in the near-infrared band. Based on characteristics of the urine, the contaminant sensor 341 includes one or more light emitting elements for emitting UV light and one or more light receiving elements for receiving a predetermined wavelength band (e.g., a near-infrared wavelength band or 550 nm to 650 nm).

When there is an object other than a contaminant (e.g., urine) that emits fluorescence or phosphorescence in a predetermined wavelength band (e.g., a near-infrared wavelength band or 550 nm to 650 nm), the object may be misidentified as a contaminant even though the object is a target to be collected when (e.g., when only) the contaminant sensor 341 is used, and thus a sensor for identifying an object that emits fluorescence or phosphorescence in such a predetermined wavelength band is required. The robot 300 according to various embodiments of the disclosure may further include a moisture sensor 342 to prevent such misidentification. According to various embodiments of the disclosure, the moisture sensor 342 may detect a change in permittivity or resistance caused by contact of the liquid with the sensor electrode, and may detect the liquid present on the floor based on such a change. As illustrated in FIGS. 1A and 2B, the moisture sensor 342 according to various embodiments of the disclosure may be disposed to vertically face the floor or may be disposed to have a predetermined angle from the floor. The moisture sensor 342 according to various embodiments of the disclosure may be disposed further ahead of the main body than the contaminant sensor 341 is.

According to various embodiments of the disclosure, the anti-fall sensor 343 may be provided under the main body to detect a step (e.g., a cliff) having a predetermined height or more on the driving path. The anti-fall sensor 343 may be provided at an edge of the main body to prevent the main body from falling in advance. Further, when the wheel 151 falls below the step, the robot 300 may be stuck to the step or may not be able to return to the original position of the robot. Therefore, according to various embodiments of the disclosure, the anti-fall sensor 343 may be disposed adjacent to the wheel 151. As such, the one or more anti-fall sensors 343 disposed in an edge area of the lower side and/or an area adjacent to the wheel 151 may prevent a driving error caused by the robot 300 falling below the step. The anti-fall sensor 343 may detect the step based on, e.g., a distance between the anti-fall sensor 343 and the floor. The anti-fall sensor 343 may be implemented as, e.g., an infrared sensor, but is not limited thereto.

Although not illustrated in FIG. 3, referring to FIGS. 1A to 2B, sensors according to various embodiments of the disclosure may further include a LiDAR sensor, a 3D sensor, and the like. The LiDAR sensor may generate a map including an obstacle. The 3D sensor may obtain 3D shape data of an object positioned on the driving path.

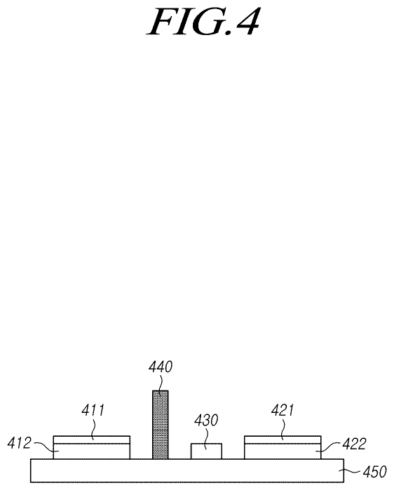

FIGS. 4 to 7 illustrate a structure of an optical sensor according to various embodiments of the disclosure.

According to various embodiments of the disclosure, the contaminant sensor 341 may be provided in various structures. For example, the contaminant sensor 341 may include a light emitting element, a main light receiving element, and a sub light receiving element. For example, the contaminant sensor 341 may include a light emitting element, a main light receiving element, a sub light receiving element, and a barrier. For example, the contaminant sensor 341 may include a light emitting element, a barrier, and a light receiving element separated into a main area and a sub area by the barrier. For example, the contaminant sensor 341 may include a light emitting element, a first light receiving element receiving a first wavelength band (e.g., 550 nm to 650 nm), and a second light receiving element receiving a second wavelength band (e.g., 350 nm to 450 nm).

Referring to FIG. 4, in various embodiments of the disclosure, the contaminant sensor 341 may include a light emitting element 430, a main light receiving element 422, and a sub light receiving element 412. The main light receiving element 422 is disposed more adjacent to the light emitting element 430 than the sub light receiving element 412. The main light receiving element 422 is provided adjacent to the light emitting element 430 to receive fluorescence or phosphorescence induced by the light emitting element 430. In contrast, the sub light receiving element 412 is provided to be spaced apart from the light emitting element 430 by a predetermined distance. This is because the sub light receiving element 412 is provided not to receive fluorescence or phosphorescence induced by the light emitting element 430 but to detect light having a predetermined wavelength band received from an external environment.

In various embodiments of the disclosure, the main light receiving element 422 and the sub light receiving element 412 may be disposed to be separated with respect to the barrier 440. The main light receiving element 422 may be disposed in one area adjacent to the light emitting element 430, and the secondary light receiving element 412 may be disposed in the other area separated by the barrier 440. Light (e.g., UV light) emitted by the light emitting element 430 is not introduced into the sub light emitting element 412 by the barrier 440. Further, fluorescence or phosphorescence induced by light irradiated from the light emitting element 430 is not introduced into the sub light receiving element 412 by the barrier 440. In other words, the barrier 440 is disposed to divide the sub light receiving element 412 from the light emitting element 430 and the main light receiving element 422, and has a very low transmittance in a predetermined wavelength band (e.g., a near-infrared wavelength band or 550 nm to 650 nm).

According to various embodiments of the disclosure, the light emitting element 430, the main light receiving element 422, the sub light receiving element 412, and the barrier 440 may be mounted on one or more substrates 450 (e.g., a printed circuit board (PCB)). According to various embodiments of the disclosure, the light emitting element 430 and the main light receiving element 422 may be separately mounted on two or more substrates, and in some cases, the barrier 440 may be excluded. For example, when the main light receiving element 422 and the light emitting element 430 are mounted on a first substrate, the sub light receiving element 412 is mounted on a second substrate, and the first and second substrates are spaced apart from each other by a predetermined distance, the barrier 440 may be omitted. Since the barrier 440 is provided so that light emitted or induced by the light emitting element 430 is not received by the sub light receiving element 412, the barrier 440 may be omitted if a predetermined distance is provided between the first substrate and the second substrate.

According to various embodiments of the disclosure, optical filter layers 411 and 421 may be disposed on the main light receiving element 422 and the sub light receiving element 412. The optical filter layers 411 and 421 may be implemented as, e.g., optical bandpass filters. The optical filter layers 411 and 421 may pass light of a predetermined wavelength band (e.g., a near-infrared wavelength band or 550 nm to 650 nm). FIG. 4 illustrates that the optical filter layer is directly bonded to an upper side of the light receiving element, but is not limited thereto.

In various embodiments of the disclosure, when (for example, when only) the main light receiving element 422 is configured in the contaminant sensor 341, if light having a predetermined wavelength band is received from an external environment to the main light receiving element 422, the optical sensor identifies that a sensing event has occurs and transfers a detection signal to the controller 310. Such misdetection increases a driving time of the robot 300 and causes the battery of the robot 300 to be consumed more than without misdetection. According to various embodiments of the disclosure, the sub light receiving element 412 may constitute the contaminant sensor 341 together with the main light receiving element 422, and may serve to verify a result of detection by the main light receiving element 422.

According to various embodiments of the disclosure, if light having a predetermined wavelength band is detected by the main light receiving element 422, the controller 310 identifies whether light having such a predetermined wavelength band is detected by the sub light receiving element 412. According to an embodiment, even when light of the near-infrared wavelength band is detected by the main light receiving element 422, if light of the near-infrared wavelength band is also detected by the sub light receiving element 412, the controller 310 may determine that no contaminants are detected. In other words, when light of the near-infrared wavelength band is detected (for example, detected only) by the main light receiving element 422, the controller 310 may determine that contaminants are detected. As such, the sub light receiving element 412 may prevent the robot 300 from misdetection of contaminants due to entrance of light from the external environment.

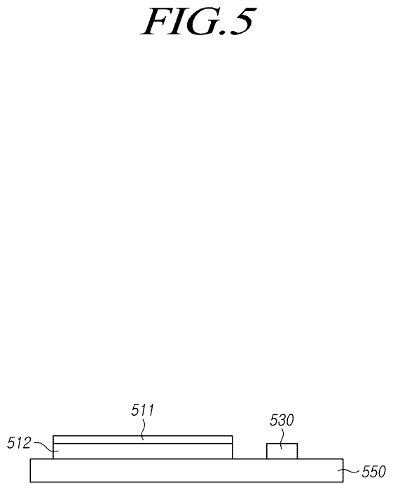

Referring to FIG. 5, in various embodiments of the disclosure, the contaminant sensor 341 includes a light emitting element 530 and a light receiving element 512. Here, one light receiving element 512 may be implemented. According to various embodiments of the disclosure, the light emitting element 530 and the light receiving element 512 may be mounted on one or more substrates 550.

According to various embodiments of the disclosure, an optical filter layer 511 may be disposed on the light receiving element 512. The optical filter layer 511 may be implemented as, e.g., an optical bandpass filter. The optical filter layer 511 may pass light of a predetermined wavelength band (e.g., a near-infrared wavelength band or 550 nm to 650 nm). FIG. 5 illustrates that the optical filter layer 511 is directly bonded to an upper side of the light receiving element 512, but is not limited thereto.

In various embodiments of the disclosure, one light receiving element 512 may function as the main light receiving element 422 of FIG. 4 and the sub light receiving element 412 of FIG. 4 by adjusting a light emitting period of the light emitting element 530. The controller 310 may periodically turn on or off the light emitting element 530. In the period in which the light emitting element 530 is turned on, the light receiving element 512 functions as the main light receiving element 422 of FIG. 4, and in the period in which the light emitting element 530 is turned off, the light receiving element 512 functions as the sub light receiving element 412 of FIG. 4. More specifically, in the period in which the light emitting element 530 is turned on, the light emitting element 530 may emit UV light toward the floor, and the light receiving element 512 may receive fluorescence or phosphorescence of a predetermined wavelength band induced by the UV light. Thereafter, in the period in which the light emitting element 530 is turned off, the light emitting element 530 may not emit UV light, and the light receiving element 512 may not receive fluorescence or phosphorescence induced by UV light. When fluorescence or phosphorescence having a predetermined wavelength band is detected by the light receiving element 512 in the period in which the light emitting element 530 is turned on, and fluorescence or phosphorescence having such a wavelength band is detected by the light receiving element 512 even in the period in which the light emitting element 530 is turned off, the controller 310 may identify that a sensing event by the contaminant sensor 341 is caused by external light, not by contaminants (e.g., urine). In contrast, when fluorescence or phosphorescence having the predetermined wavelength band is detected by the light receiving element 512 in the period in which the light emitting element 530 is turned on, and fluorescence or phosphorescence having such a wavelength band is not detected by the light receiving element 512 in the period in which the light emitting element 530 is turned off, the controller 310 may determine that a sensing event by the contaminant sensor 341 is caused by the contaminant

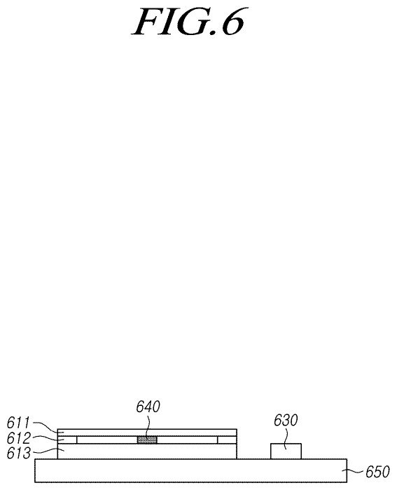

Referring to FIG. 6, in various embodiments, the contaminant sensor 341 includes a light emitting element 630 and a light receiving element 613. In the embodiment illustrated in FIG. 6, the light receiving element 613 may be implemented as a sensor device (e.g., a position sensing device (PSD) or a line charge-coupled device (CCD)) capable of detecting a point (or a position) where light is received. According to various embodiments of the disclosure, the light emitting element 630 and the light receiving element 613 may be mounted on one or more substrates 650.

According to various embodiments of the disclosure, an optical filter layer 611 may be disposed on the light receiving element 613. The optical filter layer 611 may be implemented as, e.g., an optical bandpass filter. The optical filter layer 611 may pass light of a predetermined wavelength band (e.g., a near-infrared wavelength band or 550 nm to 650 nm). As illustrated in FIG. 6, the optical filter layer 611 may be coupled to the light receiving element 613 by a sealing material 612. Here, one or more spacers (not shown) may be disposed between the optical filter layer 611 and the light receiving element 613.

According to various embodiments of the disclosure, a barrier 640 may be disposed on the light receiving element 613. According to various embodiments of the disclosure, the barrier 640 may divide the light receiving element 613 into a plurality of areas, and accordingly, one light receiving element 613 may be divided into a main light receiving element area and a sub light receiving element area. Among the plurality of areas, an area adjacent to the light emitting element 630 is defined as a main light receiving element area, and an area positioned far from the light emitting element is defined as a sub light receiving element area. The main light receiving element area performs the same function as the main light receiving element 422 of FIG. 4, and the sub light receiving element area performs the same function as the sub light receiving element 412 of FIG. 4. If fluorescence or phosphorescence of a predetermined wavelength band is detected through the main light receiving element area and fluorescence or phosphorescence having such a wavelength band is detected through the sub light receiving element area, the controller 310 may determine that a sensing event by the contaminant sensor 341 is caused by external light, not by contaminants (e.g., urine). In contrast, if fluorescence or phosphorescence having the predetermined wavelength band is detected through the main light receiving element area and fluorescence or phosphorescence having such a wavelength band is not detected through the sub light receiving element area, the controller 310 may determine that a sensing event by the contaminant sensor 341 is caused by the contaminant.

According to various embodiments of the disclosure, a height of the barrier 640 is equal to or smaller than a width between the optical filter layer 611 and the light receiving element 613. In other words, when the width between the optical filter layer 611 and the light receiving element 613 is equal to the height of the barrier 640, the barrier 640 may contact a lower side of the optical filter layer 611. When the height of the barrier 640 is smaller than the width between the optical filter layer 611 and the light receiving element 613, the barrier 640 is spaced apart from the lower side of the optical filter layer 611 by a predetermined distance. As such, according to various embodiments of the disclosure, due to the sealing material 612 or the spacer, a space having a predetermined width may be provided between the optical filter layer 611 and the light receiving element 613, and the barrier 640 may be disposed in the corresponding space. Meanwhile, the sealing material or spacer is not necessarily provided, and may be omitted in some cases.

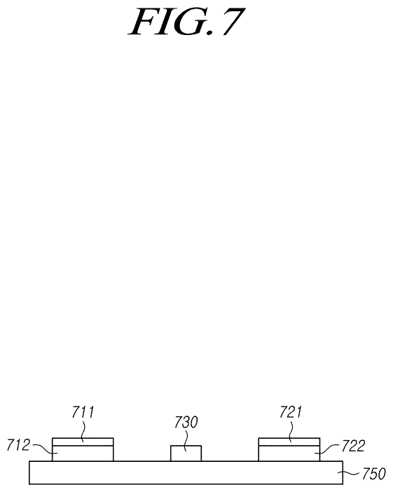

Referring to FIG. 7, in various embodiments of the disclosure, the contaminant sensor 341 includes a light emitting element 730, a first light receiving element 722, and a second light receiving element 712. Here, the first light receiving element 722 is designed to receive a first wavelength band, and the second light receiving element 712 is designed to receive a second wavelength band. The first wavelength band includes, e.g., a near-infrared wavelength band or 550 nm to 650 nm. The second wavelength band includes, e.g., a near-ultraviolet wavelength band or a wavelength band of 350 nm to 450 nm. A first optical filter layer 721 passing light of a near-infrared wavelength band or 550 nm to 650 nm may be disposed on the first light receiving element 722, and a second optical filter layer 711 passing light of a near-ultraviolet wavelength band or 350 nm to 450 nm may be disposed on the second light receiving element 712. Accordingly, the robot 300 may detect fluorescence or phosphorescence induced by the light emitting element through the first light receiving element 722, and detect a step through the second light receiving element 712. Here, detection of the step may be determined based on an intensity of a near-ultraviolet wavelength band emitted by the light emitting element 730 and received and measured by the second light receiving element 712 or a position where light is detected in an entire area of the second light receiving element 712. In other words, the first light receiving element 722 is provided to detect contaminants on the floor, and the second light receiving element 712 is provided to detect a step higher than or equal to a predetermined height on the driving path.

According to various embodiments of the disclosure, the light emitting element 730, the first light receiving element 722, and the second light receiving element 712 may be mounted on one or more substrates 750.

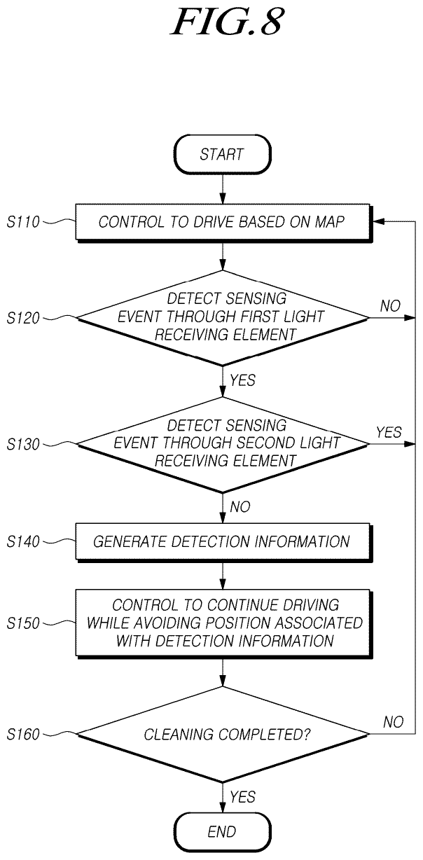

FIGS. 8 to 13 illustrate examples of a control method according to various embodiments of the disclosure.

Hereinafter, the light receiving element of the contaminant sensor is referred to as a first light receiving element or a second light receiving element, but the first light receiving element may be understood to correspond to “the main light receiving element 422 of FIG. 4”, “the light receiving element 512 when the light emitting element of FIG. 5 is in the turn-on mode”, “the main light receiving element area of FIG. 6”, and “the first light receiving element 722 of FIG. 7”. Further, the second light receiving element may be understood to correspond to “the sub light receiving element 412 of FIG. 4”, “the light receiving element 512 when the light emitting element of FIG. 5 is in the turn-off mode”, “the sub light receiving element area of FIG. 6”, or “the second light receiving element 712 of FIG. 7”.

FIG. 8 is a flowchart illustrating a method for detecting and driving while avoiding a contaminant (e.g., urine) using two or more light receiving elements (or two or more light receiving element areas).

According to various embodiments of the disclosure, the controller 310 may control the driver 350 based on a map (S110).

The map may be pre-stored in the memory 320 or may be generated through one or more sensors. Further, the map may be received from another electronic device (e.g., a user terminal, another robot 300). The map may be generated by the LiDAR sensor and updated by other sensors. For example, when there is no map stored in the memory 320 or a predetermined time elapses from a time when the map is stored, the robot 300 may generate an initial map through the LiDAR sensor and update the initial map using other sensing data obtained while driving along the initial map. According to various embodiments of the disclosure, the controller 310 controls the driver 350 based on the map. In this case, the controller 310 may identify a driving area and a no-driving area in the map, and may generate a driving path to traverse an entire area of the driving area. The controller 310 controls the driver 350 to move along the driving path. Meanwhile, in an embodiment, the map may be stored and managed in an area of the non-volatile memory 320.

Meanwhile, according to various embodiments of the disclosure, the controller 310 may emit light (e.g., UV light) of a near-ultraviolet wavelength band to the floor through the light emitting element while the robot 300 drives. Thereafter, the robot 300 may receive fluorescence or phosphorescence of another wavelength band induced by the emitted light of the near-ultraviolet wavelength band through the contaminant sensor 341, which is described below.

According to various embodiments of the disclosure, the controller 310 may detect a sensing event through the first light receiving element (S120). When the sensing event is detected through the first light receiving element, the controller 310 may detect the sensing event through the second light receiving element (S130).

According to various embodiments of the disclosure, the controller 310 may identify (or detect) a sensing event through the first and second light receiving elements. The sensing event refers to an event in which a value measured by the light receiving element exceeds a preset threshold. According to various embodiments of the disclosure, the thresholds of the first and second light receiving elements may be set to be the same.

If the sensing event is not detected through the first light receiving element, the controller 310 controls driving based on the map. Further, if the sensing event is detected through the second light receiving element, the controller 310 may control to drive based on the map regardless of the sensing event by the first light receiving element.

According to various embodiments of the disclosure, if the sensing event is detected through the first light receiving element and the sensing event is not detected through the second light receiving element, the controller 310 may generate or obtain detection information (S140).

According to various embodiments of the disclosure, the controller 310 does not generate detection information if the sensing event by the first light receiving element is not identified, and does not generate detection information if the sensing event by the second light receiving element is identified even when the sensing event by the first light receiving element is identified. In other words, when a sensing event occurs only by the first light receiving element of the first and second light receiving elements, the controller 310 may generate detection information.

According to various embodiments of the disclosure, the controller 310 may control the driver 350 to drive the robot 300 while avoiding a point where the detection information is generated, i.e., the position associated with the detection information (S150).

According to various embodiments of the disclosure, the position associated with the detection information includes a point where the detection information is generated. In some cases, the position associated with the detection information may be a predetermined area including the point where the detection information is generated. According to an embodiment, if the detection information is obtained, the controller 310 may set a predetermined area including the position associated with the detection information as a no-driving area, and may control to detour such a no-driving area. A diameter of the no-driving area may be set to differ based on the type of contaminant. For example, for urine, rather than a simple liquid, the diameter of the no-driving area may be set to be larger. Meanwhile, the detection information may include position information depending on cases, and in this case, the position associated with the detection information may be designated as position information included in the detection information.

According to various embodiments of the disclosure, if additional driving is required after an avoidance driving, the controller 310 may perform the additional driving based on the map, and if not necessary, the controller 310 may end the driving (S160).

Here, the determination that additional driving is not necessary or the requirement for additional driving may be determined based on the map. For example, when the entire driving path based on the map is driven, there is no remaining driving path, and thus the controller 310 may end the driving. As another example, when only a part of the driving path is driven, the controller 310 continues to drive because there is a remaining driving path.

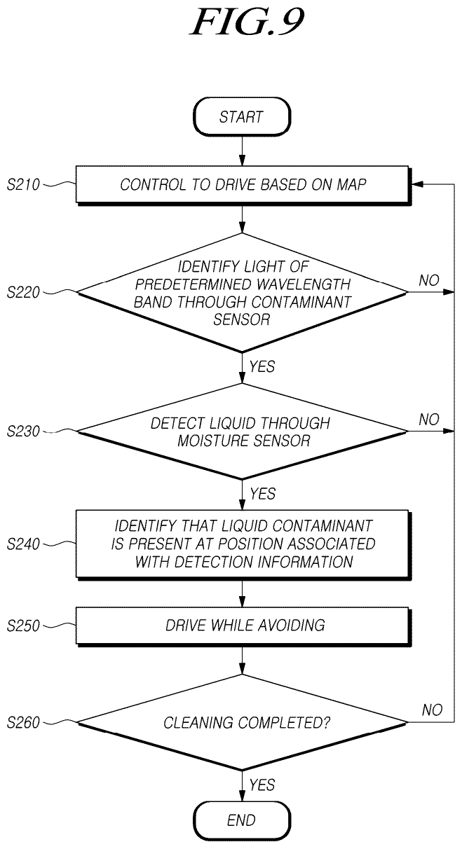

FIG. 9 is a flowchart illustrating a method in which a robot 300 detects a liquid contaminant and drives while avoiding the liquid contaminant in a case where a sensing operation by the contaminant sensor 341 is performed before a sensing operation by the moisture sensor 342.

According to various embodiments of the disclosure, the controller 310 may control the driver 350 based on a map (S210). Since S210 corresponds to S110, no further description is given.

According to various embodiments of the disclosure, the controller 310 may identify light of a predetermined wavelength band through the contaminant sensor 341 (S220). Here, the contaminant sensor 341 may be understood with reference to FIGS. 4 to 7, and detection information generated through the contaminant sensor 341 may be referred to below as first detection information.

According to various embodiments of the disclosure, the controller 310 may receive a fluorescence or phosphorescence of a near-infrared wavelength band or 550 nm to 650 nm through the contaminant sensor 341, and may identify that a contaminant is detected when such fluorescence or phosphorescence is received through the contaminant sensor 341. Meanwhile, according to various embodiments of the disclosure, not only the contaminant sensor 341 but also the moisture sensor 342 may be additionally used.

According to various embodiments of the disclosure, the controller 310 may detect a liquid through the moisture sensor 342 (S230).

According to various embodiments of the disclosure, the controller 310 may detect a liquid on the floor through the moisture sensor 342, and may generate detection information if the liquid is detected. The detection information generated by the moisture sensor 342 may be referred to as second detection information. In other words, the first detection information may be defined as being generated by the contaminant sensor 341, and the second detection information may be defined as being generated by the moisture sensor 342.

In the disclosure, the contaminant sensor 341 uses light of a near-ultraviolet wavelength band or a near-infrared wavelength band, and may likely cause misdetection. Further, even when the robot 300 is supposed to pass through an object, if the object is misdetected as a contaminant according to properties of the material, the robot 300 may avoid driving. Accordingly, the robot 300 according to various embodiments of the disclosure further includes a moisture sensor 342 to compensate for such misdetection.

According to various embodiments of the disclosure, even when fluorescence or phosphorescence of a predetermined wavelength band is received at one point through the contaminant sensor 341, the controller 310 may identify whether a material positioned at the one point is a liquid through the moisture sensor 342. Even if light of a predetermined wavelength band is received by the contaminant sensor 341, if the moisture sensor 342 identifies ○ that the material is not liquid, the controller 310 may control the robot 300 to pass through the position (i.e., the position associated with the detection information of FIG. 8) where the contaminant is identified by the contaminant sensor 341, rather than avoiding the position.

However, according to various embodiments of the disclosure, if a liquid is detected by the moisture sensor 342, the controller 310 may identify that a liquid contaminant is present at a position where a predetermined wavelength and the liquid are detected (S240).

As described above in S230, if the contaminant sensor 341 identifies that the contaminant is present, the controller 310 may identify the liquid through the moisture sensor 342. Even if the material is identified as a contaminant by the contaminant sensor 341, if the contaminant is solid, the contaminant does not spread along the driving path. Rather, when the robot 300 applied to various embodiments of the disclosure is a cleaning robot 300, solid contaminants are objects to be removed by a cleaning tool such as the brush 160, rather than objects to be avoided. As such, even when the material is primarily identified as a contaminant by the contaminant sensor 341, if the material is not a liquid contaminant, the robot 300 may not avoid the contaminant identified by the contaminant sensor 341 but may drive through the position where the detection information is generated.

According to various embodiments of the disclosure, the controller 310 may control the driver 350 to avoid the position where the liquid contaminant is identified to be present (S250).

According to various embodiments of the disclosure, the controller 310 may determine a driving speed, a driving pattern, and a driving direction of the robot 300 based on the first and second detection information. According to various embodiments of the disclosure, the position where the liquid contaminant is detected refers to a position where light of a predetermined wavelength band is received by the contaminant sensor 341 and the liquid is detected through the moisture sensor 342. According to various embodiments of the disclosure, a predetermined area including the position where the liquid contaminant is detected may be set as a no-driving area. The controller 310 may control the driver 350 to drive through a remaining area other than the no-driving area. A diameter of the no-driving area may be set to differ based on the type of contaminant. For example, for urine, the diameter of the no-driving area may be set to be larger than that for simple urine.

According to various embodiments of the disclosure, if additional driving is required after driving while avoiding the position where the liquid contaminant is detected, the controller 310 may perform additional driving based on the driving path, but if additional driving is not necessary (i.e., not required), the controller 310 may end the driving (S260).

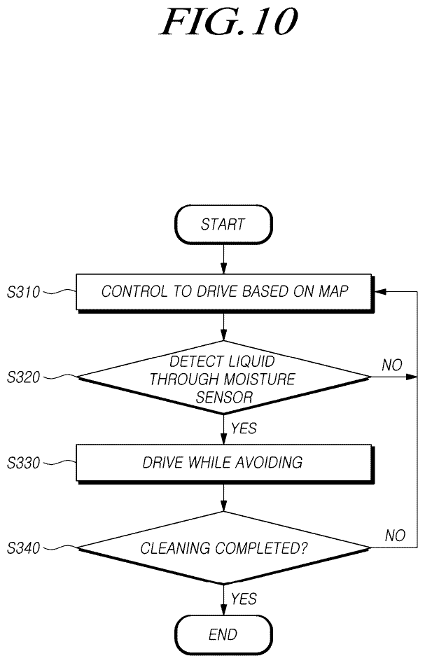

FIG. 10 is a flowchart illustrating a method in which the robot 300 identifies a liquid through the moisture sensor 342 and drives while avoiding the liquid in a case where a sensing operation by the moisture sensor 342 is performed before a sensing operation by the contaminant sensor 341.

According to various embodiments of the disclosure, the controller 310 may control the driver 350 based on the map (S310). Since S310 corresponds to S110, no further description is given.

According to various embodiments of the disclosure, the controller 310 may detect a liquid through the moisture sensor 342 (S320).

According to various embodiments of the disclosure, the controller 310 may detect a liquid through the moisture sensor 342 before detecting a contaminant through the contaminant sensor 341. To that end, the moisture sensor 342 may be disposed further in front of the lower portion of the main body than the contaminant sensor 341.

According to various embodiments of the disclosure, if a liquid is detected, the controller 310 may control the driver 350 to avoid a position where the liquid is detected (S330).

A method according to various embodiments illustrated in FIG. 10 may control the robot 300 regardless of the contaminant sensor 341, unlike in the embodiment illustrated in FIG. 9. Referring to FIG. 10, according to various embodiments of the disclosure, the controller 310 may identify that there is a contaminant to be avoided if a liquid is detected by the moisture sensor 342, regardless of the contaminant sensor 341. This is distinguished from a case where a contaminant emitting light of a predetermined wavelength band is identified by the contaminant sensor 341 and, when (such as only when) the contaminant emitting light is identified as a liquid by the moisture sensor 342, is identified as a liquid contaminant to be avoided.

In the case of a dry cleaning robot, liquid is classified as an object to be avoided regardless of a type of material constituting the liquid. Accordingly, the robot 300 which is a dry cleaning robot drives while avoiding a liquid detected by the moisture sensor 342 regardless of the contaminant sensor 341. In other words, once an object is identified as a liquid by the moisture sensor 342, even when the object is identified as a contaminant by the contaminant sensor 341 later, the robot 300 drives while avoiding the detected liquid. Further, if an object is not identified as a liquid by the moisture sensor 342, even when the object is identified as a contaminant by the contaminant sensor 341 later, the robot 300 may drive over the contaminant. In various embodiments of the disclosure, even when a first detection information based on the contaminant sensor 341 of the controller 310 is identified, if a second detection information based on the moisture sensor 343 is not identified, the controller 310 may disregard or invalidate the first detection information. As the first detection information is disregarded or invalidated, the robot 300 may pass through without avoiding a position associated with the first detection information.

According to various embodiments of the disclosure, the controller 310 may perform additional driving based on the driving path if additional driving is required after driving while avoiding the position where the liquid is detected and, if additional driving is not necessary, may end driving (S340).

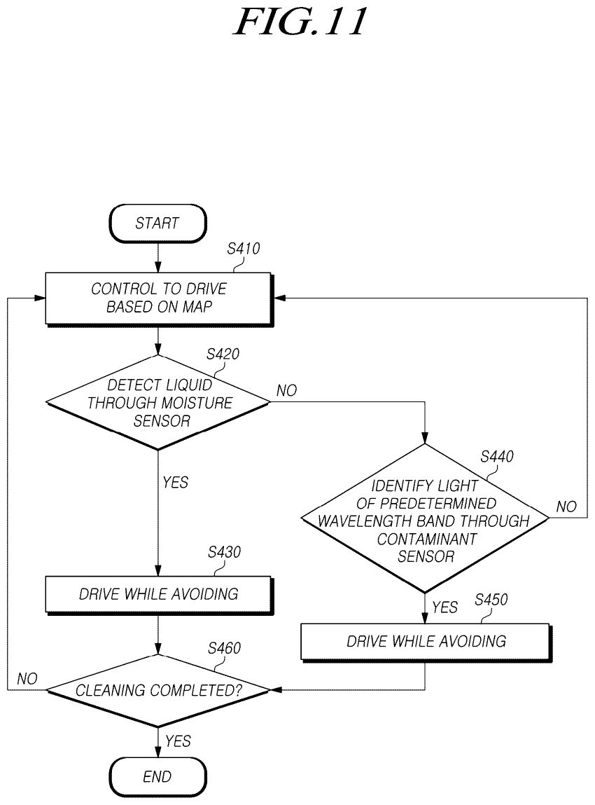

FIG. 11 is a flowchart illustrating a method in which the robot 300 identifies a liquid through the moisture sensor 342, detects a dried contaminant (e.g., dried urine) through the contaminant sensor 341, and drives while avoiding the dried contaminant in a case where a sensing operation by the moisture sensor 342 is performed before a sensing operation by the contaminant sensor 341.

According to various embodiments of the disclosure, the controller 310 may control the driver 350 based on the map (S410). Since S410 corresponds to S110, no further description is given.

According to various embodiments of the disclosure, the controller 310 may detect a liquid through the moisture sensor 342 (S420).

According to various embodiments of the disclosure, the controller 310 may detect a liquid through the moisture sensor 342 before detecting a contaminant through the contaminant sensor 341. To that end, the moisture sensor 342 may be disposed further in front of the lower portion of the main body than the contaminant sensor 341.

According to various embodiments of the disclosure, when a liquid is detected through the moisture sensor 342, the controller 310 may control the driver 350 to avoid a position where the liquid is detected (S430).

According to various embodiments of the disclosure, when no liquid is detected through the moisture sensor 342, the controller 310 may detect fluorescence or phosphorescence of a predetermined wavelength band through the contaminant sensor 341 (S440).

According to various embodiments of the disclosure, if fluorescence or phosphorescence of the predetermined wavelength band is detected through the contaminant sensor 341, the controller 310 may determine that a solid contaminant is detected, and may control the driver 350 to avoid the solid contaminant (S450).

The solid contaminant may be removed by a separate cleaning tool (e.g., the brush 160, a rotating plate, and a cleaning cloth) provided in the robot 300, but may be avoided in some cases. For example, in a case of a wet cleaning robot 300, if the contaminant is liquefied by contacting a liquid, a contamination range may be enlarged by the cleaning tool. A method according to various embodiments of the disclosure may detect a solid contaminant and control the driver 350 to avoid the detected solid contaminant, thereby preventing liquefaction of the solid contaminant and enlarging a resulting contamination. Meanwhile, if fluorescence or phosphorescence of the predetermined wavelength band is not detected through the contaminant sensor 341, this means that neither liquid nor contaminants are present, and thus, the controller 310 continues driving based on the existing map.

Referring to S420, S430, S440, and S450, when at least one of a first detection information by the contaminant sensor 341 and a second detection information by the moisture sensor 343 is detected, the robot 300 according to various embodiments of the disclosure may drive while avoiding a position associated with the first detection information and the second detection information. In this case, the robot 300 may maximally prevent a spread of the contamination range due to various factors.

According to various embodiments of the disclosure, if additional driving is required, the controller 310 may perform additional driving based on the driving path, and if not necessary, the controller 310 may end the driving (S460).

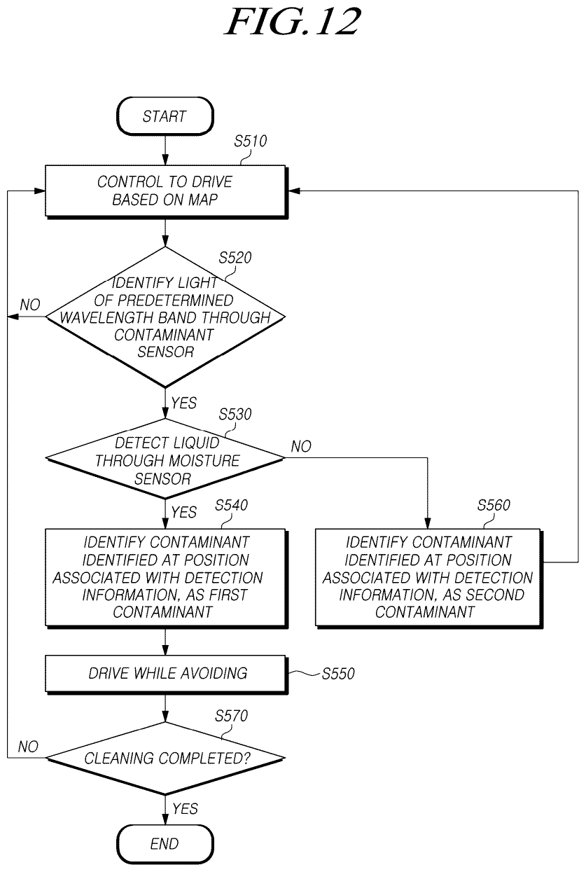

FIG. 12 is a flowchart illustrating a method in which the robot 300 identifies a contaminant through the contaminant sensor 341 and avoids or passes through the contaminant based on a state (e.g., liquid or solid state) of the contaminant identified by the moisture sensor 342 in a case where a sensing operation by the contaminant sensor 341 is performed before a sensing operation by the moisture sensor 342.

According to various embodiments of the disclosure, the controller 310 may control the driver 350 based on a map (S510). Since S510 corresponds to S110, no further description is given.

According to various embodiments of the disclosure, the controller 310 may detect fluorescence or phosphorescence of a predetermined wavelength band through the contaminant sensor 341 (S520).

According to various embodiments of the disclosure, when fluorescence or phosphorescence of a predetermined wavelength band is detected by the contaminant sensor 341, the controller 310 may detect liquid through the moisture sensor 342 (S530).

According to various embodiments of the disclosure, the controller 310 may determine a type of the contaminant detected through the contaminant sensor 341 as any one of first contaminant and the second contaminant, based on a moisture data obtained by the moisture sensor 342. Here, the first contaminant represents a liquid contaminant, and the second contaminant represents a solid contaminant.

According to various embodiments of the disclosure, when moisture is detected by the moisture sensor 342, the controller 310 may identify the contaminant detected by the contaminant sensor 341 as the first contaminant (liquid contaminant) (S540).

According to various embodiments of the disclosure, the controller 310 may obtain first detection information through the contaminant sensor 341 and second detection information through the moisture sensor 343. In this case, the controller 310 may identify the contaminant identified at a position associated with the first detection information as the liquid contaminant based on the second detection information.

According to various embodiments of the disclosure, if a contaminant is identified as the first contaminant, the controller 310 may control the driver 350 so that the robot 300 avoids the liquid contaminant (S550). Accordingly, it is possible to prevent the liquid contaminants from expanding as the robot 300 drives.

Meanwhile, according to various embodiments of the disclosure, if moisture is not detected by the moisture sensor 342, the controller 310 may identify the contaminant detected by the contaminant sensor 341 as the second contaminant (solid contaminant) (S560).

According to various embodiments of the disclosure, the controller 310 may obtain a first detection information through the contaminant sensor 341 and a second detection information through the moisture sensor 343. When the first detection information is obtained through the contaminant sensor 341, but the second detection information is not obtained because moisture is not detected, the controller 310 may identify the contaminant identified at a position associated with the first detection information as a solid contaminant.

As such, when the contaminant is identified as the solid contaminant, the controller 310 may control the driver 350 to allow the robot 300 to pass through the solid contaminant without avoiding the contaminant, but the disclosure is not limited thereto. If the robot 300 according to various embodiments of the disclosure is a dry cleaning robot, the robot 300 may be controlled to drive based on a map without avoiding solid contaminants, but if the robot 300 according to various embodiments of the disclosure is a wet cleaning robot, the robot 300 may be controlled to drive while avoiding solid contaminants.

According to various embodiments of the disclosure, if additional driving is required, the controller 310 may perform additional driving based on the driving path, and if not necessary, the controller 310 may end the driving (S570).

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the robot 100, 200, or 300 described herein may be implemented as a hardware component, a software component, and/or a combination thereof. The program may be executed by any system capable of executing computer readable instructions.

The software may include computer programs, codes, instructions, or combinations of one or more thereof and may configure the processing device as the software is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as the functions are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. A robot comprising:
a main body;
one or more optical sensors provided at a lower portion of the main body;
memory storing at least one program; and
at least one processor, comprising processing circuitry, electrically connected with the one or more optical sensors and the memory, and configured to execute at least one instruction of the program,
wherein the optical sensor includes one or more light emitting elements configured to emit light of a first wavelength band, one or more light receiving elements configured to receive light of a second wavelength band induced by the light of the first wavelength band, and one or more optical filter layers arranged on the one or more light receiving elements to pass the light of the second wavelength band, and
wherein the at least one processor, individually and/or collectively, is configured to:
obtain first detection information based on two or more sensing values obtained through the one or more light receiving elements; and
control to avoid a position associated with the first detection information when the first detection information is obtained.

2. The robot of claim 1, wherein the light receiving elements include first and second light receiving elements,
wherein the first light receiving element is disposed adjacent to the one or more light emitting elements,
wherein the second light receiving element is disposed farther from the one or more light emitting elements than the first light receiving element is, and
wherein the at least one processor, individually and/or collectively, is configured to:
obtain the first detection information based on a first sensing value obtained through the first light receiving element and a second sensing value obtained through the second light receiving element.

3. The robot of claim 2, wherein the first and second light receiving elements are arranged on a single substrate.

4. The robot of claim 2, wherein the first and second light receiving elements are arranged on different substrates, respectively, and wherein the different substrates are disposed to be spaced apart from each other by a predetermined distance.

5. The robot of claim 2, wherein the first and second light receiving elements are spatially separated by a barrier.

6. The robot of claim 5, wherein the one or more light emitting elements are disposed more adjacent to the barrier than the first light receiving element is.

7. The robot of claim 2, wherein the at least processor, individually and/or collectively, is configured to:
obtain the first detection information when the first sensing value exceeds a preset first threshold, and the second sensing value is less than a preset second threshold.

8. The robot of claim 1, further comprising one or more moisture sensors,
wherein the one or more moisture sensors are electrically connected with the at least one processor,
wherein the at least one processor, individually and/or collectively, is configured to:
obtain second detection information when a sensing value obtained through the one or more moisture sensors exceeds a threshold; and
avoid a position associated with the second detection information when the second detection information is obtained, and disregards the first detection information when the second detection information is not obtained.

9. The robot of claim 1, further comprising
one or more moisture sensors,
wherein the one or more moisture sensors are electrically connected with the at least one processor,
wherein the at least one processor, individually and/or collectively, is configured to:
obtain second detection information when a sensing value obtained through the one or more moisture sensors exceeds a threshold; and
avoid a position associated with the first and second detection information when both the first detection information and the second detection information are obtained; and
disregard the obtained first detection information or second detection information when at least a portion of the first and second detection information is not obtained.

10. The robot of claim 1, wherein the at least one processor, individually and/or collectively, configured to:
periodically control the one or more light emitting elements in a turn-on mode or a turn-off mode; and
obtain the first detection information based on a first sensing value obtained through the one or more light receiving elements in the turn-on mode and a second sensing value obtained through the one or more light receiving elements in the turn-off mode.

11. The robot of claim 1, wherein the one or more light receiving elements includes a first area receiving light of a second wavelength band induced by the light of the first wavelength band and disposed adjacent to the one or more light emitting elements and a second area receiving the light of the first wavelength band and disposed farther from the one or more light emitting elements than the first area is, and
wherein the at least one processor, individually and/or collectively, is configured to:
obtain first detection information based on a first sensing value obtained through the first area and a second sensing value obtained through the second area; and
control to avoid a position associated with the first detection information when the first detection information is obtained.

12. The robot of claim 11, wherein the first and second areas are separated by a barrier.

13. The robot of claim 1, wherein the first wavelength band is a near-ultraviolet wavelength band, and the second wavelength band is a near-infrared wavelength band.

14. A robot, comprising:
a main body;
one or more optical sensors provided at a lower portion of the main body;
memory storing at least one program; and
at least one processor, comprising processing circuitry, electrically connected with the one or more optical sensors and the memory, and configured to execute at least one instruction of the program,
wherein the optical sensor includes one or more light emitting elements configure to emit light of a first wavelength band, one or more first light receiving elements configured to receive light of a second wavelength band induced by the light of the first wavelength band, a second light receiving element for receiving the light of the first wavelength band, a first optical filter layer arranged on the first light receiving element to pass the light of the second wavelength band, and a second optical filter layer arranged on the second light receiving element to pass the light of the first wavelength band, and
wherein the at least on processor, individually and/or collectively, is configured to:
obtain first detection information based on first and second sensing values obtained through the first and second light receiving elements and controls to avoid a position associated with the first detection information when the first detection information is obtained; and
obtain second detection information based on the second sensing value obtained through the second light receiving element and controls to move a predetermined distance or time in a direction opposite to a position associated with the second detection information when the second detection information is obtained.

15. The robot of claim 14, wherein the light receiving elements include first and second light receiving elements,
wherein the first light receiving element is disposed adjacent to the one or more light emitting elements,
wherein the second light receiving element is disposed farther from the one or more light emitting elements than the first light receiving element is, and
wherein the at least one processor, individually and/or collectively, is configured to:
obtain the first detection information based on a first sensing value obtained through the first light receiving element and a second sensing value obtained through the second light receiving element.

16. The robot of claim 15, wherein the first and second light receiving elements are arranged on a single substrate.

17. The robot of claim 15, wherein the first and second light receiving elements are arranged on different substrates, respectively, and wherein the different substrates are disposed to be spaced apart from each other by a predetermined distance.

18. A method for controlling a robot, the robot including an optical sensor that includes one or more light emitting elements emitting light of a first wavelength band, one or more light receiving elements for receiving light of a second wavelength band induced by the light of the first wavelength band, and one or more optical filter layers arranged on the light receiving element to pass the light of the second wavelength band, the method comprising:
obtaining two or more sensing values through the one or more light receiving elements;
obtaining first detection information based on the two or more sensing values; and
controlling to avoid a position associated with the first detection information when the first detection information is obtained.

19. The method of claim 18, further comprising:
obtaining second detection information when a sensing value obtained through one or more moisture sensors exceeds a threshold,
wherein the robot further comprises the one or more moisture sensors electrically connected with at least one processor; and
avoiding a position associated with the second detection information when the second detection information is obtained, and disregards the first detection information when the second detection information is not obtained.

20. The method of claim 18, further comprising
obtaining second detection information when a sensing value obtained through one or more moisture sensors exceeds a threshold,
wherein the robot further comprises the one or more moisture sensors electrically connected with at least one processor; and
avoiding a position associated with the first and second detection information when both the first detection information and the second detection information are obtained; and
disregarding the obtained first detection information or second detection information when at least a portion of the first and second detection information is not obtained.
